(19) United States
(12) Patent Application Publication
(10) Pub. No.: US 2018/0290876 A1
(43) Pub. Date: Oct. 11, 2018

(54) SYSTEMS AND METHODS FOR FORMULATING NAIL POLISH

(71) Applicant: DreaMau LLC, Baton Rouge, LA (US)

(72) Inventor: Quy That Ton, Baton Rouge, LA (US)

(73) Assignee: DreaMau LLC, Baton Rouge, LA (US)

(21) Appl. No.: 15/886,821

(22) Filed: Feb. 1, 2018

Related U.S. Application Data
(60) Provisional application No. 62/452,990, filed on Feb. 1, 2017.

(51) Int. Cl. B67D 7/02; A45D 34/00

(52) U.S. Cl. CPC B67D 7/0227; A45D 2034/005; A45D 34/00

(57) ABSTRACT

A nail polish color formulation machine comprises a processing device; at least one plunger; at least one nail polish cartridge having a syringe-like dimensions with a plunger receiving opening at a proximal end and an outlet opening at a distal end. The nail polish cartridges are configured to receive a plunger and the plunger is designed to move up and down inside nail polish cartridge. The nail polish color formulation machine comprises at least one motor that is mechanically coupled to the at least one plunger to move the plunger vertically up and down, and open/close devices that close the outlet openings of the nail polish cartridges responsive to not having a nail polish bottle on the open/close device. The nail polish color formulation machine receives a desired nail polish color, and actuates the motors to move the plungers up and down inside the nail polish cartridges.

### CROSS-REFERENCE TO RELATED APPLICATION

This application claims benefit to U.S. provisional patent application Ser. No. 62/452,990, filed on Feb. 1, 2017, which is incorporated by reference herein.

### TECHNICAL FIELD

The present disclosure is generally related to nail polish and, more particularly, is related to systems and methods for formulating nail polish.

### BACKGROUND

Nail polish is designed to improve the appearance and condition of nails. It also can protect nails from breakage. In its simplest form, a nail polish is a liquid solution of pigments, solvents and film formers. Nail polish is typically presented to consumers in a bottle with a brush applicator. The solution is applied to the nail and then allowed to dry at which point it becomes a smooth, hard, colored film. Nail polishes contain a number of ingredients including pigments, film formers, plasticizers, resins, solvents and other additives.

There are two types of pigments used in nail polishes. Mineral pigments like titanium dioxide and colored iron oxides and organic pigments like red #6 and yellow #5. The United States strictly limits the pigments that are allowed for use in nail polish.

A film former may be used for to make the nail polish attractive. The ingredient most frequently used is nitrocellulose. Nitrocellulose is a dangerous compound to work with and so only a limited number of manufacturers can produce nail polish.

Resins like shellac and acrylic polymers may be added to improve the properties of the nitrocellulose film. This makes the film tougher and helps the nail polish last longer. Plasticizers may be used to improve the film flexibility. Camphor and dibutyl phthalate are most often used as plasticizers.

Solvents such as alcohols, esters, and ketones may be used to help the product spread and dry quickly. Finally, additives such as viscosity modifiers and UV protectors may be included in formulations.

Due to the chemicals used to formulate nail polish, these nail polish formulations may be difficult to handle. There are heretofore unaddressed needs with previous solutions in handling these formulations.

### SUMMARY

Example embodiments of the present disclosure provide systems of formulating nail polish. Briefly described, in architecture, one example embodiment of the system, among others, can be implemented as follows: a user interface that receives user input; a processing device; at least one nail polish cartridge with a plunger and an outlet opening; at least one motor that is mechanically coupled to the plunger to move the plunger vertically up and down; and memory that includes a color formulation manager having instructions stored in the memory, the instructions being executed by the processing device, the instructions comprising logic configured to: receive a desired nail polish color based on the received user input from the user interface, and actuate the at least one motor to move the plunger up and down inside the at least one nail polish cartridge.

Embodiments of the present disclosure can also be viewed as providing methods for formulating nail polish. In this regard, one embodiment of such a method, among others, can be broadly summarized by the following steps: providing a plurality of motors, each of the plurality of motors associated with a cartridge, each cartridge comprising a plunger and an outlet opening and containing a liquid; receiving user input from a user input device; determining desired liquid mixture parameters from the user input; determining a combination of cartridges and a volume of liquid to dispense from each of the cartridges of the combination to achieve the desired liquid mixture parameters; and actuating a subset of the plurality of motors to move the plungers in the determined combination of cartridges, each of the plungers configured to move inside the associated cartridges to dispense the determined volume of liquid from each of the determined combination of multiple cartridges.

Other systems, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a block diagram that illustrates an example embodiment of a nail polish formulation machine having a color formulation manager.

FIG. 2 is an example embodiment of a nail polish formulation machine, such as that shown in FIG. 1, having a nail polish cartridge and an open/close device.

FIG. 3 shows an example embodiment of electrical and mechanical components inside a housing of a nail polish formulation machine, such as that shown in FIG. 2.

FIG. 4 shows an example embodiment of a coupling bar mechanically coupled to a plunger inside the housing of a nail polish formulation machine, such as that shown in FIG. 3.

FIG. 5 shows an example embodiment of an open/close device of a nail polish formulation machine, such as that shown in FIG. 2.

FIG. 6A shows a front perspective of a more detailed view of an open/close device of a nail polish formulation machine, such as that shown in FIG. 5.

FIG. 6B shows a rear perspective of a more detailed view of an open/close device of a nail polish formulation machine, such as that shown in FIG. 5.

FIG. 7A shows a more detailed view of a nail polish cartridge, such as that shown in FIG. 2.

FIG. 7B shows an overhead perspective view of the outlet area of a nail polish cartridge, such as that shown in FIG. 7A.

FIG. 7C shows an exploded view of the outlet area of a nail polish cartridge, such as that shown in FIG. 7A.

FIG. 8A shows a more detailed view of a nail polish cartridge, such as that shown in FIG. 2, having a piston.

FIG. 8B shows a more detailed view of a piston, such as that shown in FIG. 8A.

FIG. 9 is a high-level flow diagram that illustrates an example embodiment of the architecture, functionality, and/or operation of nail polish formulation machine, such as that shown in FIG. 1.

### DETAILED DESCRIPTION

Exemplary systems are first discussed with reference to the figures. Although these machines are described in detail, they are provided for purposes of illustration only and various modifications are feasible. After the exemplary machines are described, examples of flow diagrams of the systems are provided to explain the manner in which nail polish is dispensed.

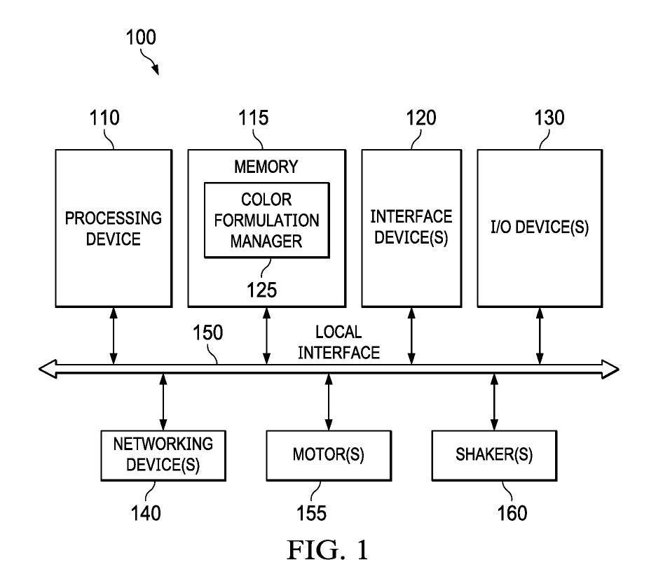

FIG. 1 is a block diagram that illustrates an embodiment of nail polish formulation machine 100 having color formulation manager 125. As indicated in FIG. 1, nail polish formulation machine 100 comprises processing device 110, memory 115, one or more user interface devices 120, one or more I/O devices 130, and one or more networking devices 140, each of which is connected to local interface 150. Processing device 110 may include any custom made or commercially available processor, a central processing unit (CPU) or an auxiliary processor among several processors associated with nail polish formulation machine 100, a semiconductor based microprocessor (in the form of a microchip), or a macroprocessor. Memory 115 may include any one or a combination of volatile memory elements (e.g., random access memory (RAM, such as DRAM, SRAM, etc.)) and nonvolatile memory elements (e.g., ROM, hard drive, tape, CDROM, etc.).

One or more user interface devices 120 comprise those components with which the user can interact with nail polish formulation machine 100. Where nail polish formulation machine 100 comprises a computer or similar device, these components may comprise those typically used in conjunction with a PC such as a keyboard and mouse.

One or more I/O devices 130 comprise components used to facilitate connection of nail polish formulation machine 100 to other devices and, therefore, for instance, comprise one or more serial, parallel, small system interface (SCSI), universal serial bus (USB), or IEEE 1394 (e.g., Firewire™) connection elements. Networking devices 140 comprise the various components used to transmit and/or receive data over networks (not shown), where provided. By way of example, networking devices 140 include a device that can communicate both inputs and outputs, for instance, a modulator/demodulator (e.g., modem), a radio frequency (RF) or infrared (IR) transceiver, a telephonic interface, a bridge, a router, and a network card, among others.

Memory 115 normally comprises various programs (in software and/or firmware) including an operating system (O/S) (not shown) and color formulation manager 125. The O/S controls the execution of programs, such as color formulation manager 125, and provides scheduling, input-output control, file and data management, memory management, and communication control and related services. The communication control includes actuating motors 155 and shakers 160, which will be described in further details below.

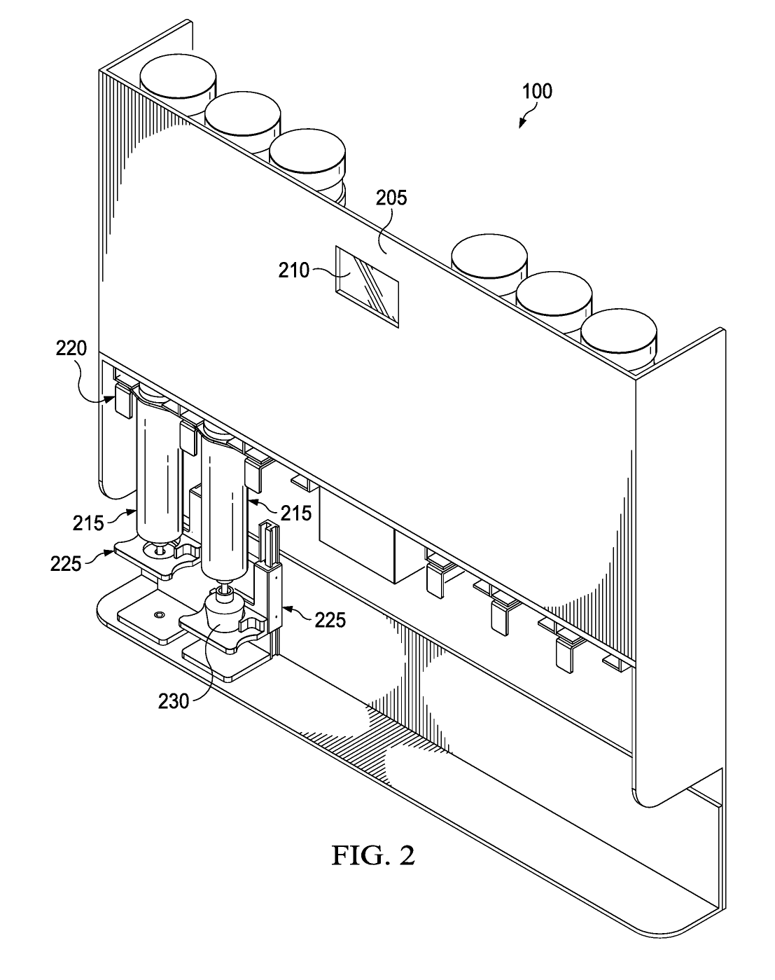

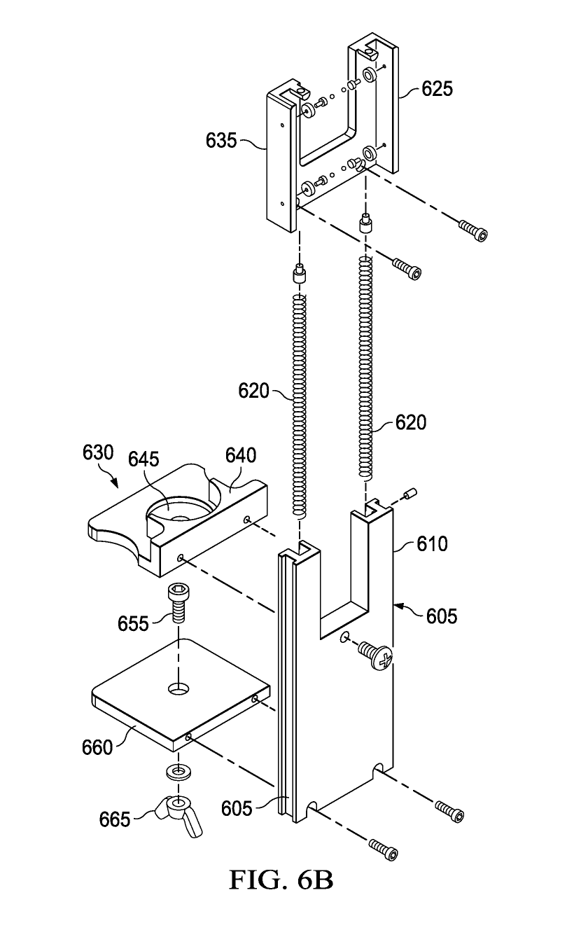

FIG. 2 is an example embodiment of nail polish formulation machine 100, such as that shown in FIG. 1, having nail polish cartridge 215 and open/close device 225. Nail polish color formulation machine 100 includes housing 205 that houses motors 155 (not shown), processing device 110 (not shown), and memory 115 (not shown). Housing 100 may include display 210 that interfaces with a user for dispensing nail polish color from nail polish cartridge 215, which has a syringe-like dimension with plunger receiving opening 730 (FIG. 7) at proximal end 735 and outlet opening 715 at distal end 710. Nail polish cartridge 215 is shown and described in more detail in FIG. 7.

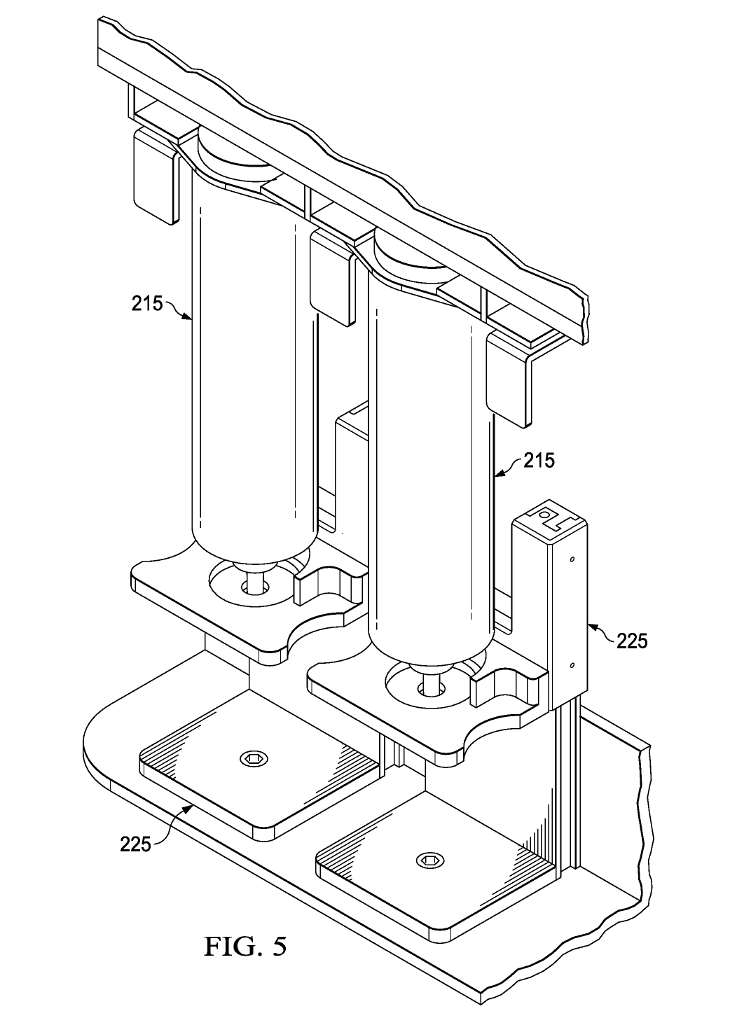

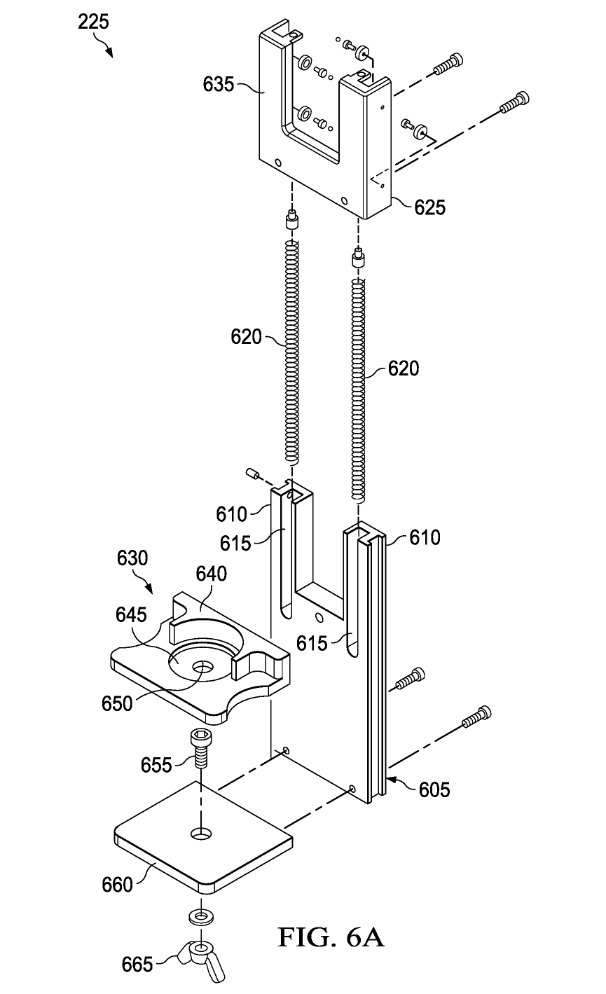

In an example embodiment, nail polish cartridge 215 slides into cartridge holder 220, positioning nail polish cartridge 215 vertically such that plunger receiving opening 730 is above outlet opening 715. Nail polish cartridge 215 may be positioned above open/close device 225 that opens and closes the outlet opening of at least one nail polish cartridge responsive to nail polish bottle 230 being placed on open/close device 225. Open/close device 225 is shown and described in more detail in FIGS. 5 and 6.

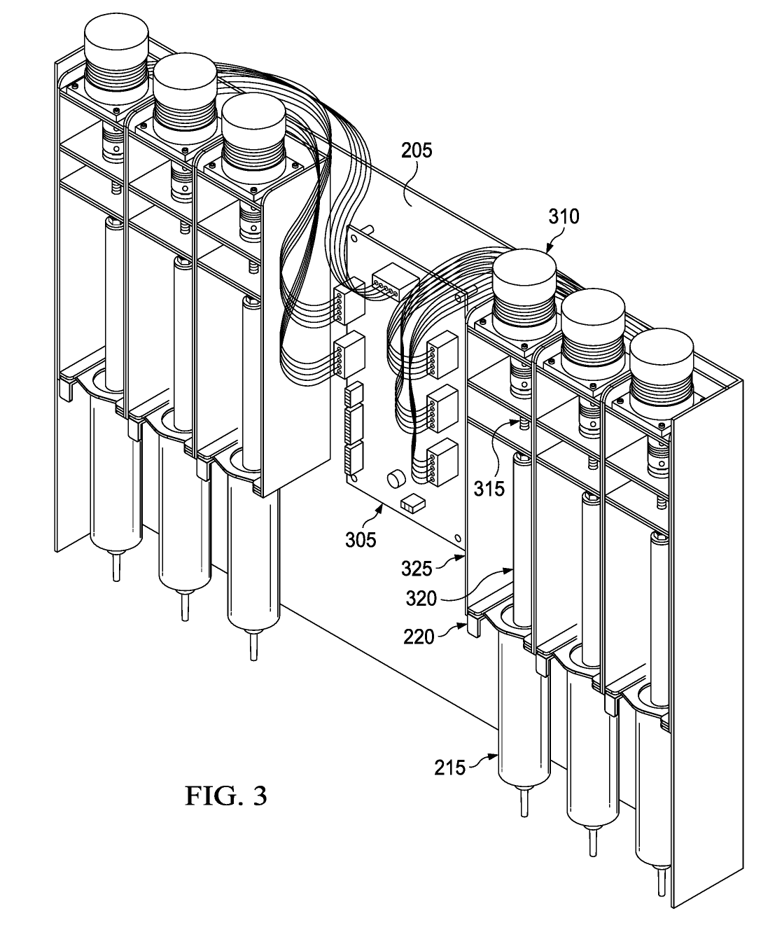

FIG. 3 shows an example embodiment of electrical and mechanical components inside a housing of a nail polish formulation machine, such as that shown in FIG. 2. In this example embodiment, the inside of housing 205 includes PCB board 305 that is configured with processing device 110 (FIG. 1) and memory 115 (FIG. 1). PCB board 305 is electrically coupled to interface device 120 (FIG.1, but not shown in FIG. 3) and I/O devices 130 (FIG.1, but not shown in FIG. 3). Housing 205 may include racks 325 that store motors 310, coupling bars 315, plungers 320, and cartridge holder 220. Motors 310 may be mechanically coupled to the at least one plunger 325 to move at least one plunger 320 vertically up and down. Motors 310 are electrically coupled to processing device 110, which actuates motors 310 to move plunger 320 up and down inside nail polish cartridge 215.

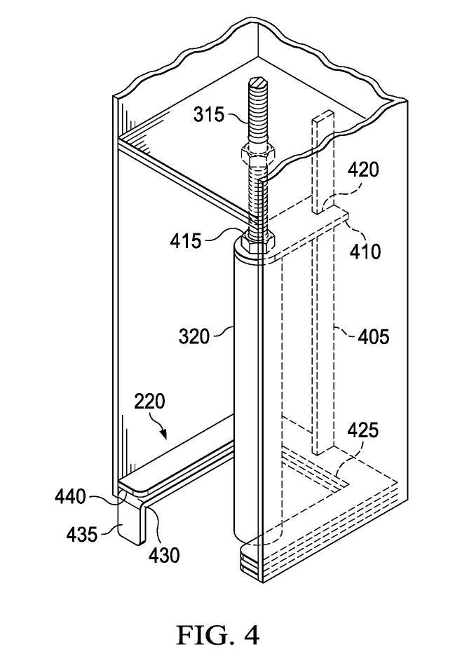

FIG. 4 shows an example embodiment of coupling bar 315 mechanically coupled to plunger 320 inside the housing of nail polish formulation machine 100, such as that shown in FIG. 3. Coupling bar 315 may be a threaded bar, such as that shown in FIG. 4. In an alternative embodiment, Plunger 320 is a piston. In an example embodiment, plunger 320 is attached to nut 415, with coupling bar 315 threaded through nut 415. Plunger 320 is also attached to guide bar 410 that includes groove 420, which guides plunger 320 up and down plunger track 405. Groove 420 also prevents plunger 320 from turning with coupling bar 315 so that plunger 320 may move up and down coupling bar 315 as motor 310 (FIG. 3) turns coupling bar 315 clockwise and counterclockwise. Cartridge holder 220 is also shown in FIG. 4, having top “U” shaped structure 425 and bottom “U” shaped structure 435 that are attached to each other and forming “U” shaped slot 440 in nail polish cartridge 215 (FIG. 3), and slides therein. Vertical bar 435 on cartridge holder 220 facilitates guiding nail polish cartridge 215 (FIG. 3) into “U” shaped slot 440.

FIG. 5 shows an example embodiment of open/close device 225 of nail polish formulation machine 100, such as that shown in FIG. 2. Open/close device 225 is positioned below nail polish cartridge 215 and closes outlet opening 715 (FIG. 7) of nail polish cartridge 215. Open/close device 225 is shown and described in more detail in FIG. 6.

FIG. 6 shows a more detailed view of preassembled open/close device 225 of nail polish formulation machine 100, such as that shown in FIG. 5. Open/close device 225 includes “U” shaped base 605, wherein arms 610 of “U” shaped based 605 includes slots 615 in which springs 620 are inserted. Slots 615 function similar to tracks such that tracks 625 slide up and down within slots 615 of arms 610. Platform 630 is attached to base 635 of tracks 625. Platform 630 includes polish bottle holder 640 that has a semi-circle shape and recess 645 to facilitate holding nail polish bottle 230 (FIG. 2) during nail polish dispensing from nail polish cartridge 215 to nail polish bottle 230 (FIG. 2).

Recess 645 includes bore 650 that is fitted with cap 655 that facilitates closing outlet opening 715 of nail polish cartridge 215 responsive to platform 630 not holding a nail polish bottle. Cap 655 opens outlet opening 715 responsive to platform 630 holding nail polish bottle 230 as nail polish bottle 230 pushes cap 655 down and away from outlet opening 715. Cap 655 fits through bore 650 but is large enough such that cap 655 does not pass through bore 650. Cap 655 may be held in position via plate 660 and nut 665 that screws on a thread portion of cap 655.

FIG. 7 shows a more detailed view of nail polish cartridge 215, such as that shown in FIG. 2. In this example embodiment, nail polish cartridge 215 includes cylindrical body 705 attached with bottle engaging structure 720 at distal end 710 and radial flange 725 at proximal end 735. Radial flange 725 slides along and is held in position by “U” shaped slot 440 (FIG. 4) of cartridge holder 220 (FIG. 4). Bottle engaging structure 720 may be attached with slender tube 710 having outlet opening 715. Bottle engaging structure 720 engages nail polish bottle 230 as slender tube 710 is inserted into nail polish bottle 230 to dispense nail polish from nail polish cartridge 215 to nail polish bottle 230.

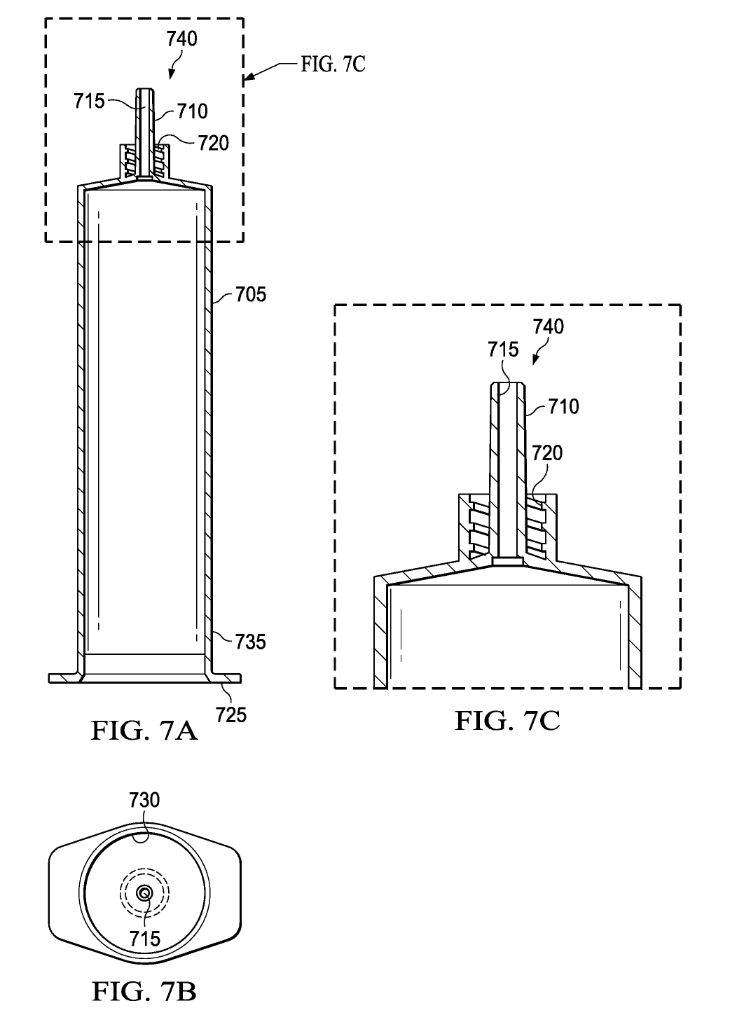

FIG. 8 shows a more detailed view of nail polish cartridge 215B, such as that shown in FIG. 2, having piston 805. FIG. 8 is a layout diagram that illustrates an example embodiment of nail polish cartridge 215, such as that shown in FIG. 7. In this example, the layout diagram of nail polish cartridge 215B of FIG. 8 is similar to the architecture of nail polish cartridge 215 as described in FIG. 7. Like features are labeled with the same reference numbers, such as body 705. Nail polish cartridge 215B further includes piston 805 that is engaged by plunger 320 (FIG. 3) to facilitate dispensing nail polish from nail polish cartridge 215 (FIGS. 2 and 3). Piston 805 includes pointed cone 810 that conforms to cone shaped end 815 of cylindrical body 705 to facilitate dispensing maximum nail polish from nail polish cartridge 215B and to prevent the structure of piston 805 from deforming.

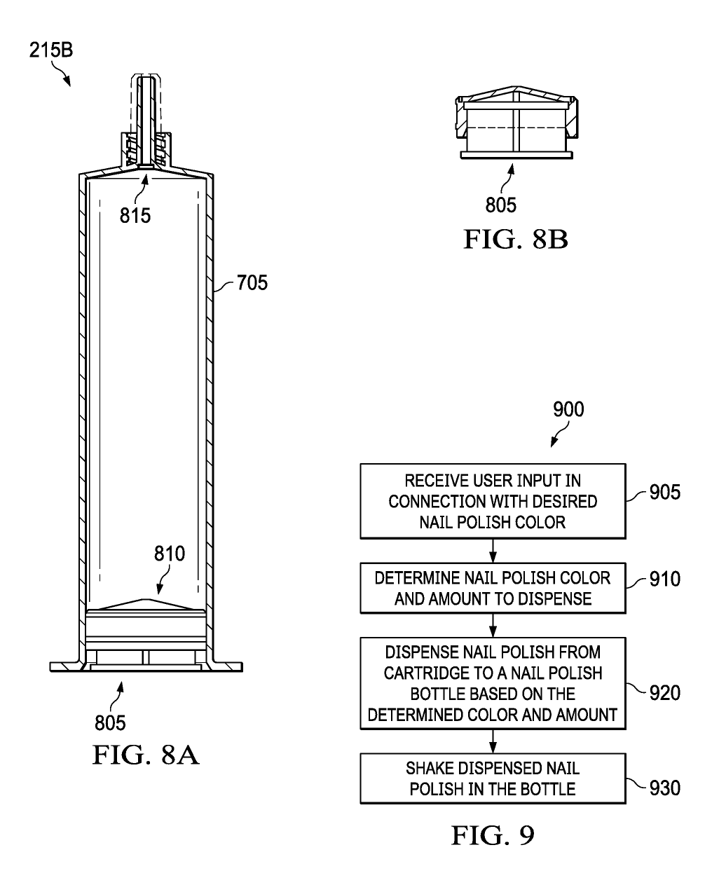

FIG. 9 provides a high-level flow diagram 900 that illustrates an example embodiment of the architecture, functionality, and/or operation of nail polish formulation machine 100, such as that shown in FIG. 1. In block 905, color formulation manager 125 of nail polish formulation machine 100 receives a user input in connection with a desired nail polish color received from the user interface 120 (FIG. 1). In block 910, color formulation manager 125 determines the nail polish color and an amount to be dispensed to create the desired nail polish color. At block 920, color formulation manager 125 actuates motor 155, 310 (FIGS. 1 and 3) to move plunger 320 inside nail polish cartridge 215 to dispense nail polish from nail polish cartridge 215 to nail polish bottle 230 based on the determined color and amount. Nail polish bottle 230, having received the dispensed nail polish, may be placed in shaker 160 to mix the dispensed nail polish.

Example embodiments of the systems and methods of formulating nail polish disclosed herein have been described in terms of nail polish, but may also be applied to the formulation of other liquid materials.

The devices and methods disclosed herein can be implemented in software, hardware, or a combination thereof. In some embodiments, the system and/or method is implemented in software that is stored in a memory and that is executed by a suitable microprocessor (μP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example, but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) optical fiber and compact disc read-only memory (CD-ROM).

Note that the computer-readable medium could even be paper or another suitable medium on which the program is printed. Using such a medium, the program can be electronically captured (using, for instance, optical scanning of the paper or other medium), compiled, interpreted or otherwise processed in a suitable manner, and then stored in a computer memory. In addition, the scope of the certain embodiments of the present disclosure includes embodying the functionality of the preferred embodiments of the present disclosure in logic embodied in hardware or software-configured mediums.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented sinistrodextrally for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

1. A system comprising:
a user interface that receives user input;
a processing device;
at least one nail polish cartridge with a plunger and an outlet opening;
at least one motor that is mechanically coupled to the plunger to move the plunger vertically up and down; and
memory that includes a color formulation manager having instructions stored in the memory, the instructions being executed by the processing device, the instructions comprising logic configured to:
receive a desired nail polish color based on the received user input from the user interface, and
actuate the at least one motor to move the plunger up and down inside the at least one nail polish cartridge.

2. The system of claim 1, wherein the at least one nail polish cartridge comprises a syringe-like dimension with a plunger receiving opening at a proximal end and a dispensing opening at a distal end.

3. The system of claim 2, wherein the at least one nail polish cartridge is configured to receive the plunger at the plunger receiver opening.

4. The system of claim 3, wherein the plunger is configured to move up and down inside the at least one nail polish cartridge.

5. The system of claim 1, further comprising at least one open/close device positioned below each of the at least one nail polish cartridges configured to close the outlet opening of each of the at least one nail polish cartridges.

6. The system of claim 5, wherein the open close device comprises a U-shaped base with two arms forming the u-shape, each of the arms comprising a slot, each of which contains a spring, the slots configured to receive a base configured to slide up and down in the slots.

7. The system of claim 1, wherein the motor is mechanically coupled to the plunger with a threaded coupling bar.

8. The system of claim 7, further comprising a guide bar attached to each plunger, the guide bar comprising a groove, the groove guiding the plunger up and down an associated plunger track.

9. The system of claim 8, wherein the groove prevents the plunger from turning with the coupling bar.

10. A method comprising:
providing a plurality of motors, each of the plurality of motors associated with a cartridge, each cartridge comprising a plunger and an outlet opening and containing a liquid;
receiving user input from a user input device;
determining desired liquid mixture parameters from the user input;
determining a combination of cartridges and a volume of liquid to dispense from each of the cartridges of the combination to achieve the desired liquid mixture parameters; and
actuating a subset of the plurality of motors to move the plungers in the determined combination of cartridges, each of the plungers configured to move inside the associated cartridges to dispense the determined volume of liquid from each of the determined combination of multiple cartridges.

11. The method of claim 10, wherein each cartridge comprises a syringe-like dimension with a plunger receiving opening at a proximal end and a dispensing opening at a distal end.

12. The method of claim 10, further comprising providing an open close device positioned below each of the cartridges, the open/close device configured to close the outlet opening of each of the cartridges.

13. The method of claim 12, wherein the open close device comprises a U-shaped base with two arms forming the u-shape, each of the arms comprising a slot, each of which contains a spring, the slots configured to receive a base configured to slide up and down in the slots.

14. The method of claim 11, wherein each plunger further comprises a guide bar, the guide bar comprising a groove, the groove guiding the plunger up and down an associated plunger track.

15. A non-transitory computer readable medium comprising software, the software including instructions for:
receiving user input from a user input device;
determining desired liquid mixture parameters from the user input;
determining a combination of cartridges with associated plungers and a volume of liquid to dispense from each of the cartridges of the combination to achieve the desired liquid mixture parameters; and
actuating a subset of a plurality of motors to move plungers in the determined combination of cartridges, each of the plungers configured to move inside the associated cartridges to dispense the determined volume of liquid from each of the determined combination of multiple cartridges.
